(19) United States
(12) Patent Application Publication
(10) Pub. No.: US 2026/0189364 A1
(43) Pub. Date: Jul. 2, 2026

(54) Tensor Network-Based Hash Function Attack

(71) Applicant: Multiverse Computing S.L., DONOSTIA (ES)

(72) Inventors: Roman Orus, DONOSTIA (ES); Borja Aizpurua, DONOSTIA (ES); Sukhbinder Singh, DONOSTIA (ES); Saeed Jahromi, DONOSTIA (ES)

(21) Appl. No.: 19/284,063

(22) Filed: Jul. 29, 2025

(30) Foreign Application Priority Data
Dec. 31, 2024 (EP) 24 383 491

(51) Int. Cl. H04L 9/06

(52) U.S. Cl. CPC H04L 9/0618; H04L 9/0643

(57) ABSTRACT

A computer-implemented method for recovering a plaintext is disclosed. The plaintext (300) comprises a variable string (320). The method comprises constructing (S2) a tensor network (500) representing the variable string (320), optimizing (270) the tensor network (500), generating (S3), in a hash function generator (350), a candidate hash (370) based on the output of the tensor network (330), determining (S4) an overlap (390) between the candidate hash (370) and a reference ciphertext (380); and on reaching a zero-overlap value, determining the variable string (320), otherwise optimising the tensor network (500).

### CROSS REFERENCE TO RELATED APPLICATIONS

The present application claims priority to EP 24 383 491.8 filed 31 Dec. 2024, the entire content thereof being incorporated by reference.

### BACKGROUND OF THE INVENTION

### Field of the Invention

The present invention relates to the field of cryptography. In particular, the present invention relates to a system and method for recovering plaintext from a hashed and encrypted message.

### Brief Description of the Related Art

Security of information is critical in various sectors, including defence, finance, and personal privacy. Cryptographic protocols often rely on hash functions to protect sensitive data by transforming plaintext into hashed ciphertext.

A hash function is any function that can be used to map data of arbitrary size to fixed-size values. The values returned by the hash function are called hash values, hash codes, digests, or simply hashes. The hash functions and their associated hash tables are used in data storage and retrieval applications to reduce the amount of storage size, but also to ensure data integrity and authentication of messages.

Data integrity is the maintenance of, and the assurance of, data accuracy and consistency and is an aspect that needs to be considered in the design, implementation, and usage of any system that stores, processes, or retrieves data. The overall intent of a method, such as a hash function, for data integrity is to ensure that the data is recorded or stored exactly as intended and, upon later retrieval of the stored data, ensure that the retrieved stored data is the same as when the data was originally stored. The hash function used for data integrity aims to prevent unintended (or unintentional) changes to information in the data stored.

Recovering the original plaintext from its hashed form is typically infeasible due to the irreversible nature of hash functions, which are designed to ensure that even minor changes in the input result in significantly different outputs.

However, in certain scenarios, partial knowledge of the plaintext, such as recognizable words or patterns within an encrypted email, can provide a foundation for attacking the hashed message. Traditionally, brute-force attacks or trial-and-error guessing methods are used, but these approaches are highly inefficient for large messages or strong cryptographic algorithms.

One object of the invention is to provide a method and system which is scalable and can be used for larger key spaces.

Another object of the present invention is to provide a computer-implemented method and system that reduces computational resources for cryptanalysis.

### SUMMARY OF THE INVENTION

To this end, the present document proposed a computer-implemented method to attack hash functions and to recover a plaintext from a hashed message.

The plaintext comprises both a variable string and a fixed string. The term “string” is used in this context to indicate a sequence of characters in the plaintext. The characters may be alphanumeric characters or symbols.

The fixed string is the known part(s) of the plaintext, and the variable strings the unknown part(s) of the plaintext. For example, in a hashed mail message, the known parts or the fixed strings may be salutations, e.g. dear sir or madam, or common phrases, and the unknown parts, also called missing parts, are the variable strings.

The document introduces a method for recovering plaintext from a hashed and encrypted message using Tensor Network (TN) techniques, such as Matrix Product States (MPS) and Flexible-PEPS Quantum Circuit Simulator (FQCS).

Projected Entangled Pair States (PEPS) are a class of tensor network states used in quantum many-body physics and quantum information theory to describe quantum states of systems on a lattice. Each lattice site is associated with a tensor, and the entanglement structure of the quantum state is encoded in the connections (or indices) between these tensors.

Flexible PEPS are an extension or generalization of the standard PEPS framework designed to enhance their adaptability and efficiency in describing quantum states, particularly in systems with irregular geometries, inhomogeneities, or specific physical constraints.

Unlike traditional brute-force methods or reliance on quantum algorithms, this method leverages Tensor Networks to iteratively guess and modify portions of the plaintext. The process involves comparing the resulting hash of the modified plaintext against a reference ciphertext, continuously optimizing until the correct plaintext is revealed. This approach significantly improves the efficiency of revealing hashed messages without relying on quantum hardware.

This method therefore addresses the challenge of recovering the full plaintext from a hashed message by leveraging known portions of the plaintext and iteratively refining the remaining parts.

The variable strings are represented in an MPS or flexible PEPS network.

The tensor network is then modified iteratively to maximize the similarity between the generated candidate hash and the reference ciphertext. The method uses the generated candidate hash to compare with the reference ciphertext (reference hash) and incrementally adjusts the remaining unknown portions until the full plaintext is revealed.

The use of the Tensor Networks allows the method to scale much more efficiently than brute-force techniques, particularly for longer or more complex plaintexts. By compressing the plaintext search space into manageable segments, the method enables faster and more efficient recovery of the plaintext.

Unlike brute-force methods, which scale poorly with the size of the message, this approach allows for intelligent, optimized modifications to recover the plaintext.

This method bypasses the need for quantum hardware and provides a scalable solution to cryptanalysis through classical means. An advantage of this method is that the method can be implemented entirely on classical hardware. Unlike quantum approaches, which require access to quantum processors, this method uses classical computing resources while still offering advanced optimization capabilities, making the method more accessible and practical for cryptanalysis.

By harnessing the power of tensor networks, the method reduces the computational resources required to explore possible combinations of the plaintext. Instead of exhaustively testing all possible ones of the plaintexts, the Tensor Network structures are used to make intelligent, optimized modifications, and thereby speeds up the recovery process.

The invention is suited for cases where portions of the plaintext, such as common words or recognizable patterns, are already known, allowing the Tensor Network to focus on revealing the unknown parts.

The present disclosure also proposes a computer program product comprising logic for executing by means of a classical processor the method of the disclosure.

### BRIEF DESCRIPTION OF THE FIGURES

For a more complete understanding of the present invention and the advantages thereof, reference is now made to the following description and the accompanying drawings, in which:

FIG. 1 shows an overview of a system which can be used for performing the method set out in this document.

FIG. 2 shows an overview of the method.

FIG. 3 shows elements used in the method.

FIG. 4 shows a MPS approach of the method.

FIG. 5 shows the sweeping step used in the MPS approach of FIG. 4.

FIG. 6 shows PEPS approach of the method.

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

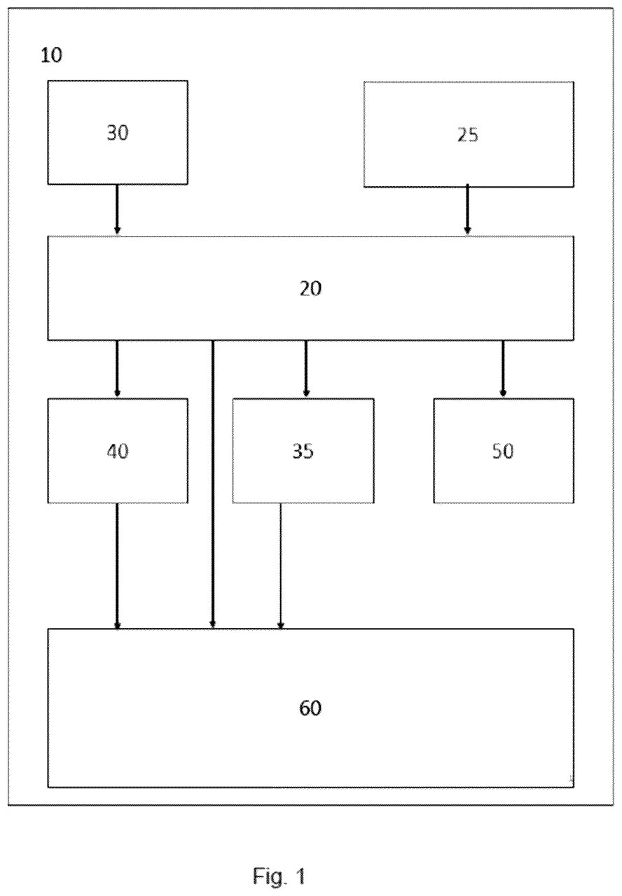

FIG. 1 shows an overview of a typical system which can be used for performing the method set out in this document. FIG. 1 shows an overview of a computing system 10 for implementing the method of this document. The computing system 10 comprises, in an example, a classical central processing unit 20 which is connected to a data storage unit 25 (i.e., one or more memory devices), and a plurality of input/output devices 30. The input/output devices 30 enable input of one or more images and an output of a result for the one or more of the images.

A graphics processing unit 35 for processing vector calculations and a field programmable gate array (FGPA) 40 for control logic that can also be connected to the central processing unit 20.

The computing system 10 may be connected to a computer network 60, such as the Internet. It will be appreciated that the computing system 10 of FIG. 1 is merely exemplary and other units or elements may be present in the computing system 10. It will also be appreciated that there may be many input/output (I/O) devices 30 located at multiple locations and that there may be a plurality of data storage units 25 also located at multiple locations. The many I/O devices 30 and data storage units 25 are connected by the computer network 60.

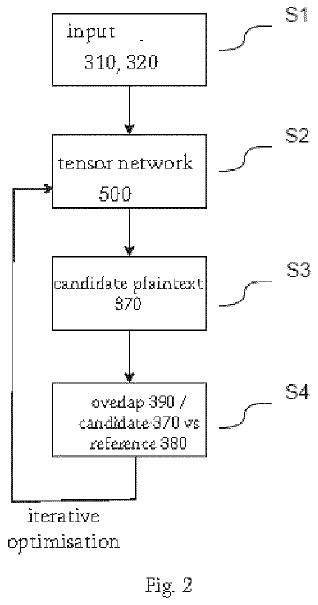

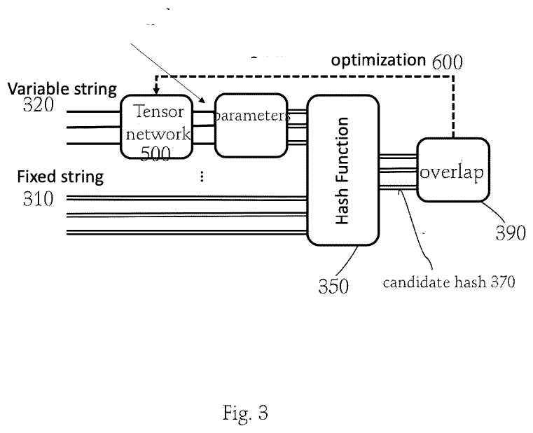

An overview of the computer implemented method for recovering plaintext from a hashed and encrypted message using Tensor Network (TN) techniques is illustrated in FIGS. 2 to 3 and will now be described.

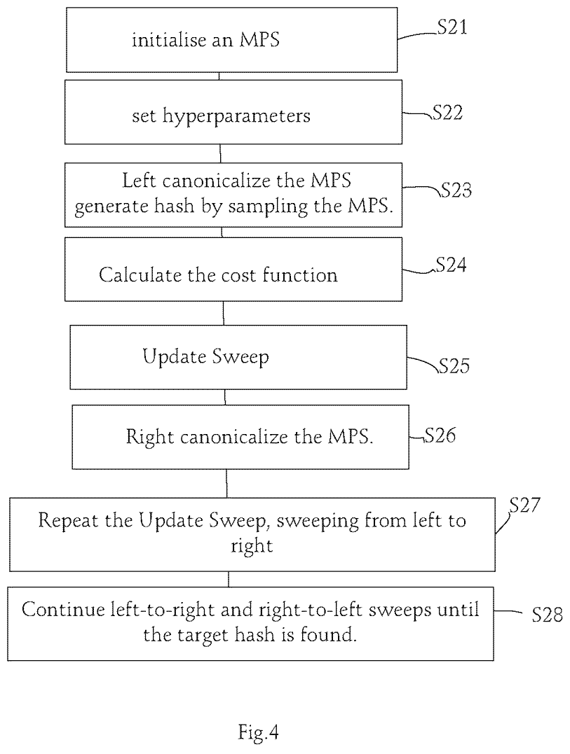

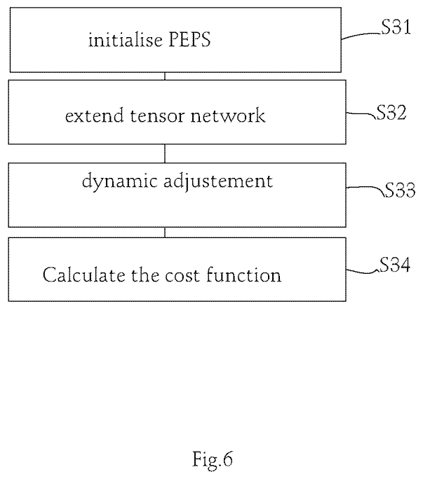

It should be noted that the present document proposes two types of tensor network techniques, either based on the use of MPS, as will be described with reference to FIG. 4, or Flexible-PEPS, as will be described with reference to FIG. 6.

A plaintext 300 comprises a fixed string 310 with a set of data, which do not need to be changed, and a variable string 320 with a set of data which needs to be changed. One example of the variable string could be unknown parts of the plaintext of the plaintext to be recovered.

The term “string” is used in this context to indicate a sequence of characters in the plaintext. The term ‘string’ can be a sequence of alphanumeric characters, symbols and/or set of pixels.

The method starts with the construction of a tensor network 500 representative of unknown portions of the plaintext, i.e. representative of the variable string 320.

In a first step S1, the plaintext 300 with both the fixed string 310 and the variable string 320 is input into the system 100 through one (or more) of the input/output devices 30 and, in step S2, the tensor network 500 is constructed to represent the variable string 320.

The tensor network 500 is created by mapping the characters of the variable string 320 to a set of tensors and defining how the tensors connect to represent the relationship between the characters. One non-limiting example would be to create a tensor for each character in the variable strong 320 and connect each tensor along edges in a chain-like network in which the tensors in the tensor network 500 are connected to neighboring tensors.

Once the tensor network 500 is constructed, the recovery process of the plaintext begins by optimizing internal parameters of the tensor network 500 (step S2). This involves adjusting bond dimensions, applying techniques like Singular Value Decomposition (SVD) to efficiently modify the tensor network 500, and using classical optimization methods, such as Adam, to update the tensors in the tensor network 500.

For MPS, the optimization process involves sweeping through the tensor network 500 from left to right and back, adjusting the tensors sequentially. In Flexible-PEPS, the optimization is more complex due to the higher dimensionality but follows a similar iterative process.

During each iteration, the variable string 320 is changed and a candidate plaintext 370 is generated. The candidate plaintext 370 is passed as an input to a hash function generator 350 in the central processing unit 20 (step S3). The hash function generator 350 is not limited to particular hash functions. Non-limiting examples of hash functions include folding, division hashing, multiplicative hashing as well as other known hashing functions and indeed customized hash functions combining several known hash functions.

The hash function generator 350 produces a candidate hash 370 which can be compared with a reference ciphertext 380 in a comparator 360. The comparator 360 measures an overlap, using Hamming distances, between the reference ciphertext 380 and the candidate hash 370 produced by the hash function generator 350.

The similarity between the candidate hash 370 generated by the modified plaintext and the reference ciphertext 380 is measured. The algorithm computes this overlap (e.g., using Hamming Distance, for example to determine the number of positions at which the characters in the modified plaintext and the reference ciphertext 380 differ) after each iteration.

The overlap 390 is used as a criterion to determine whether the correct plaintext has been found. If the overlap 390 reaches a pre-determined threshold (e.g., minimal Hamming Distance), the algorithm concludes that the correct plaintext has been recovered (or at least substantially recovered). If the overlap 390 is below the pre-determined threshold, the parameters of the tensor network 500 are further adjusted via a classical optimization algorithm 390 in the classical central processing unit 20.

The optimization algorithm is used to adjust the input parameters of the tensor network 500 to arrange for the candidate hash 370 to have an overlap 390 with the reference ciphertext in step S4. The overlap occurs when the Hamming distance is zero (or very close to zero). The iterative process continues until the correct plaintext is revealed.

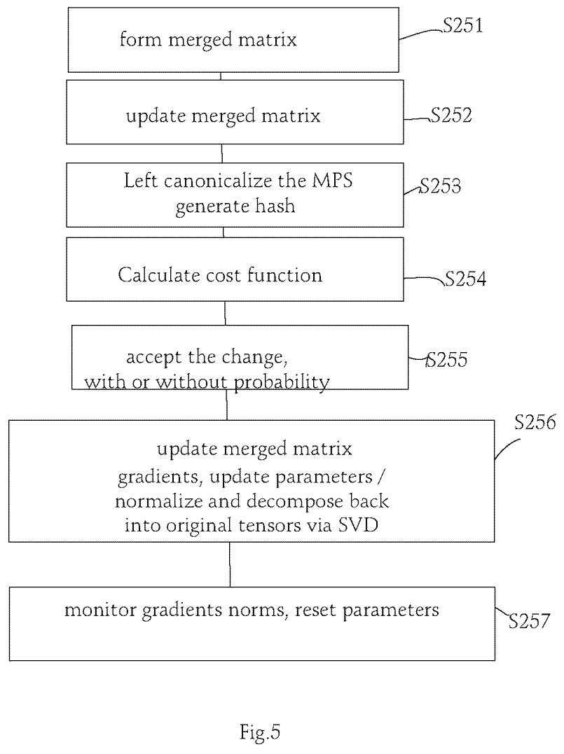

The construction and optimization of the tensor network is outlined with reference to FIGS. 4 and 5 for MPS and to FIG. 6 for PEPS.

### Matrix Product States MPS Approach

In the MPS aspect, the tensor network 500 comprises a series of tensors 520, where each tensor 520 represents a potential segment of the missing plaintext. The MPS network is initialized with random values or educated guesses based on known portions of the plaintext (e.g., common words in an email).

For MPS, the optimization process involves a sweep through the MPS tensor network from left to right and back, adjusting each tensor of the MPS tensor network sequentially, to iteratively refine the candidate plaintext until it matches the original plaintext.

In other words, the plaintext search space, according to this aspect, is compressed into manageable segments. The use of the method with manageable segments reduces the number of required operations and thus enables faster and more efficient recovery of the plaintext.

The MPS 500 is defined with open boundary conditions as

$$\vert ψ 〉 = {\sum }_{\text{?}} {A}^{\text{?}} {A}^{\text{?}} … {A}^{\text{?}} \vert {i}_{1} {i}_{2} … {i}_{N} 〉$$

$$\text{?} \text{indicates text missing or illegible when filed}$$

where Aik are tensors associated with each site k=1, 2, . . . , N, and the indices ik represent the physical states at each site.

In the first step S21, an MPS is initialized with a number of tensors equal to the hash size. It should be noted that the MPS has to be initialised. This can be done with zeros, random distribution, from previous run. In this example, the MPS is initialized using a random distribution from a uniform distribution, which gives good results, but this is not limiting and other initialization can be done.

Then, at step S22, hyperparameters for the optimization are set. The hyperparameters include a virtual bond dimension of the MPS, a step length, steps, a reset value, a cutoff value, and temperature. The step is a number of sequential updates for the same tensor in each iteration. The step length is a learning rate for parameter update. The cutoff value is a threshold for discarding smaller eigenvalues in Singular Value Decomposition (SVD). The reset value is a threshold for detecting local minima and resetting parameters. The temperature is an acceptance criterion for unfavorable change.

Then, at step S23, the method comprises left canonicalizing the MPS 500 and generating a candidate hash 370 by sampling the MPS 500. The cost function is thereafter calculated (step S24). The cost function can be calculated using the Hamming Distance between the candidate hash 370 and reference ciphertext, as explained above.

The sweep is thereafter updated (step S25). The sweep update step will be explained in reference with FIG. 5.

In the next step S26, the method comprises right canonicalizing the MPS 500, and repeating the sweep update, but sweeping from left to right (step S27).

The left-to-right and right-to-left sweeps are repeated iteratively until the overlap has reached a threshold between the candidate hash and reference ciphertext, which means that the guessed plaintext, with its candidate hash, matches the original plaintext having the reference ciphertext.

The use of SVD together with a truncation helps updating the tensors efficiently while controlling the bond dimensions. SVD is used to decompose the 2-tensor updated merged tensor. The truncation controls bond dimension so that the bond dimension does not grow to become hardware expensive.

The optimization process is guided by a cost function, ensuring the algorithm focuses on the most likely candidates for the plaintext.

The sweep update is now described with reference to FIG. 5, in this example from the right-most to the left-most.

For each tensor 520 from the right-most to the left-most, the current tensor with its neighbor tensor is merged to form a combined matrix. The combined matrix is called a “merged matrix” (Step S251).

In the next step S252, the merged matrix is updated by applying a random change to the elements of the matrix, normalized, and then decomposed back into the original tensors via Single Value Decomposition SVD. The elements of the matrix are changed, i.e. updated to get closer to the goal of optimization. The random change is a small random change which means that there are some random parameters that allow the method not to get stuck in local minima

In the next step S253, the tensor network MPS is left canonicalized and a new candidate hash 370 generated.

The cost function can be calculated at step S254 with respect to the reference ciphertext 380.

If the change is favorable, i.e. if the merged matrix leads to a candidate hash closer to the reference ciphertext with a lower energy, in this case a lower Hamming Distance, then the change is accepted. If the change is not favorable, then the change is accepted with probability,

$$P ( Δ E , T ) ∝ exp ( - \frac{Δ E}{T} )$$

with T the temperature being an acceptance criterion for unfavorable change.

ΔE represents the change in the cost function that results from applying the change to the system, here by applying the random change. Specifically:

$$Delta E = Costnew \} - Costold$$

where:
Costnew is the value of the cost function (e.g., the Hamming Distance) calculated using the new key or state after the random change.
Costold is the value of the cost function before the random change was applied.

Then, the merged matrix is updated. The update can be done by applying the Adam optimizer to update the merged matrix: calculate gradients and update parameters and normalize and decompose back into the original tensors via SVD.

Finally, gradient norms are monitored to detect local minima; if detected, reset parameters. Gradient norms monitoring can be done by monitoring the absolute value of the gradients to detect if optimisation has gotten stuck at local minima or not. If the gradients are below a certain threshold, i.e. stuck on minima, parameters are randomised again, as per step S21, to get out of local minima and continue searching.

The Adam optimizer is used to adapt the learning rate for the parameters in the tensor network, based on the first and second moments of the gradients, ensuring efficient convergence to the optimal solution.

The first and second moments of the gradients refer to statistical summaries used in optimization. The first moment is the mean (average) of the gradients, which captures the direction of the optimization path. The second moment is the uncentered variance (mean of squared gradients), which captures the scale of gradient changes and helps adapt learning rates.

The absolute value of the gradients provides a simple measure of gradient magnitude at each step.

The gradient norm quantifies the overall size of the gradient vector, typically via L2 norm (i.e., the square root of the sum of squared gradients). It is used to monitor convergence and detect local minima. These metrics are used, for instance, in the Adam optimizer to adaptively update parameters during the iterative adjustment of the tensor network.

The optimization process employs a simulated annealing approach inspired by thermodynamic principles, where each system state is associated with an energy value. The simulated annealing method allows the algorithm to escape local minima and is characterized by state and energy calculations, acceptance criteria of the state transitions based on the Metropolis-Hastings criterion. State transitions are evaluated based on the Metropolis-Hastings criterion: states with lower energy are always accepted, while higher-energy states are accepted with a probability proportional to expƒ₀(−ΔE/T)exp(−\Delta E/T), where E is the energy value and T is the temperature. This simulated annealing method allows the algorithm to escape local minima. When a new state is accepted, a gradient-based adjustment is performed using principles from Adam optimization to update variables through first and second moment estimates. This enables adaptive learning rates and smooth convergence.

By balancing exploration and exploitation, the method robustly searches the solution space and avoids premature convergence.

### Flexible-PEPS for Complex Messages:

For more complex or longer messages, Flexible-PEPS can be used.

FIG. 6 shows the process with flexible PEPS.

In the first step S31, a PEPS is initialized with a number of tensors equal to the hash size. Each lattice site is associated with a tensor, and the entanglement structure of the quantum state is encoded in the connections (or indices) between these tensors.

Then, the tensor network is extended (step S32), to come up with a flexible PEPS. The geometry of the tensor network is adapted to handle larger key spaces.

The tensor network is extended by adding new edges (bonds) between tensors to reflect potential correlations in the unknown plaintext. Each added edge represents a possible interaction or dependency between parts of the variable string. If a tensor exceeds a set number of connections (a cutoff K), the least relevant edge is removed. The least relevant edge is determined based on a measure of bond importance. This allows keeping efficient while adapting to the complexity of the message.

After, step S33, the PEPS network adjusts dynamically, deleting less relevant connections between the tensors in the tensor network, while retaining significant connections, making the process computationally efficient even for large, hashed messages. More precisely, the PEPS network adjusts dynamically by monitoring the number of connections (bonds) per tensor. If a tensor exceeds a preset limit (cutoff K), the network removes the least relevant connection to maintain efficiency. A connection is considered less relevant if the connection carries low bond entanglement entropy, meaning it contributes little to the overall correlation in the data. The term dynamic means that the geometry of the network is not fixed, i.e. that connections are added or removed during runtime based on ongoing evaluations of importance, allowing the network to adapt to the structure of the hashed message.

Finally, the cost function is calculated. The cost function can be calculated using the Hamming Distance between the candidate hash 370 and reference ciphertext.

In summary, the present invention introduces a powerful method for revealing plaintext in hashed and encrypted messages using Tensor Networks. By optimizing the search process for unknown plaintext segments and comparing generated candidate hashes against reference ciphertexts, the method achieves more efficient and scalable performance than traditional brute-force techniques.

Using MPS and Flexible-PEPS, the method allows for rapid recovery of plaintext, even for larger or more complex messages, without the need for quantum hardware.

### REFERENCE NUMERALS

10 Computing system
20 Classical central processing unit
25 Data storage unit
30 Input/output devices
35 Graphical processing unit
40 Field programmable gate array
60 Computer network
300 Plaintext
310 Fixed string
320 Variable string
335 PQC output
340 Measurement device
350 Hash function generator
360 Comparator
370 candidate hash
380 reference ciphertext
390 overlap
500 tensor network
600 Optimization algorithm

What is claimed is:

1. A computer-implemented method for recovering a plaintext, wherein the plaintext comprises a variable string and a fixed string, the method comprising:
constructing a tensor network representative of the variable string; and
iteratively optimizing the tensor network, wherein the iterative optimization comprises:
adjusting the internal parameters of the tensor network;
generating, in a hash function generator, a candidate hash from the fixed string and the output of the tensor network;
determining an overlap between the candidate hash and a reference ciphertext; and
when the overlap reaches a pre-determined threshold, determining the variable string and outputting the plaintext, otherwise further adjusting the parameters of the tensor network.

2. The method of claim 1, wherein the variable string comprises a sequence of characters, and wherein the tensor network is created by mapping the characters of the variable string to a set of tensors and defining how the tensors connect to represent the relationship between the characters.

3. The method of claim 1, wherein optimising of the tensor network comprises using a classical optimization algorithm.

4. The method of claim 1, wherein the determining is carried out by calculating the Hamming distance between the candidate hash and the reference ciphertext.

5. The method of claim 1, wherein the tensor network is one of a MPS tensor network or a flexible PEPS tensor network.

6. The method of claim 5, wherein the tensor network is a MPS tensor network, the MPS tensor network comprising a series of tensors, wherein each tensor represents a segment of the variable string.

7. The method of claim 6, comprising initializing the MPS network using a random distribution.

8. The method of claim 7, wherein optimizing the tensor network comprises sweeping through the MPS tensor network from left to right and back, adjusting each tensor of the MPS tensor network sequentially, to iteratively recover the plaintext.

9. The method of claim 8, wherein, for each tensor from the right-most to the left-most, the current tensor with its neighbour tensor is merged to form a combined matrix, and the combined matrix is updated by applying a random change, normalized, and then decomposed back into the original tensors via Single Value Decomposition SVD.

10. The method of claim 7, wherein the internal parameters of the MPS tensor networks include hyperparameters including at least one of a virtual bond dimension of the MPS, a step length, a step, a reset value, a cutoff value, and temperature.

11. The method of claim 6, comprising monitoring gradient norms are monitored to detect local minima; and if a local minima is detected, randomizing parameters of the tensor network, wherein the monitoring of gradient norms is done by monitoring an absolute value of the gradients.

12. The method of claim 1, wherein the method is implemented by a classical processor.

13. A system for recovering a plaintext, wherein the plaintext comprises a fixed string and a variable string, the system comprising:
at least one input/output device for inputting the plaintext and outputting the plaintext;
at least one tensor network, for encoding the variable string into a tensor network;
a hash function generator for creating a candidate hash from the fixed string and an output of the at least one tensor network;
a comparator for determining an overlap between the candidate hash with a reference ciphertext; and
at least one optimisation element for optimizing the parameters of the tensor network, wherein the at least one optimisation element is provided for sweeping through the at least one tensor network from left to right and back, adjusting each tensor of the tensor network sequentially, to iteratively recover the plaintext.

14. The system of claim 13, wherein the tensor network is implemented as one of a MPS or a flexible-PEPS.

15. A computer system for recovering a plaintext, wherein the plaintext comprises a variable string and a fixed string, the computer system comprising a classical processor configured to:
construct a tensor network representative of the variable string;
iteratively optimize the tensor network, wherein the iterative optimization comprises:
adjust the internal parameters of the tensor network,
generate, in a hash function generator, a candidate hash from the fixed string and the output of the tensor network;
determine an overlap between the candidate hash and a reference ciphertext; and
when the overlap reaches a pre-determined threshold, determine the variable string and outputting the plaintext, otherwise further adjust the parameters of the tensor network.

16. A computer program product comprising logic for executing, by means of a classical processor, a method for recovering a plaintext, wherein the plaintext comprises a variable string and a fixed string, the method comprising the steps of:
constructing a tensor network representative of the variable string;
iteratively optimizing the tensor network, wherein the iterative optimization comprises:
adjusting the internal parameters of the tensor network,
generating, in a hash function generator, a candidate hash from the fixed string and the output of the tensor network;
determining an overlap between the candidate hash and a reference ciphertext; and
when the overlap reaches a pre-determined threshold, determining the variable string and outputting the plaintext, otherwise further adjusting the parameters of the tensor network.
